(19) United States
(12) Patent Application Publication
(10) Pub. No.: US 2015/0245289 A1
(43) Pub. Date: Aug. 27, 2015

(54) Device and Method For Improved DRX For Use With TCP

(71) Applicant: TELEFONAKTIEBOLAGET L M ERICSSON (PUBL), Stockholm (SE)

(72) Inventors: Anzil Abdul Rasheed, Kochi (IN); Francesco Militano, Solna (SE); Swaminathan Vasanth Rajaraman, Espoo (FI); Vesa Virkki, Espoo (FI)

(73) Assignee: Telefonaktiebolaget L M Ericsson (publ), Stockholm (SE)

(21) Appl. No.: 14/431,081

(22) PCT Filed: Sep. 26, 2012
(86) PCT No.: PCT/SE2012/051021

§ 371 Date: Mar. 25, 2015

(51) Int. Cl. H04W 52/02; H04L 12/863; H04W 28/02

(52) U.S. Cl. CPC H04W 52/0216; H04W 28/0221; H04L 47/6255; H04W 80/06

(57) ABSTRACT

A TCP Proxy node (110) for use in a communications network (100), the TCP Proxy node (110) being arranged to receive TCP Packets originating from a first node (105) in a core network in the communications network and to transmit said TCP Packets for reception by an end user (120,121, 122) in a radio access network in the communications network (100). The TCP proxy node (110) is arranged to be informed about an inactivity period during which the end user (120,121, 122) is unable to receive TCP Packets, and to schedule said transmissions of TCP Packets so that they are received by the end user (120,121, 122) outside of said inactivity period.

### TECHNICAL FIELD

The present invention discloses a TCP proxy node for improved use of TCP with DRX, and a method for use with a TCP function for improved use of TCP with DRX.

### BACKGROUND

In many Internet connections between a server and a user, for example a user who watches clips on Youtube, traffic is generated in the server and sent as TCP (Transport Control Protocol) packets to the user. The TCP Packets are usually transmitted to the user by means of such mechanisms as TCP ACK, RTT (Round Trip Time), flow-control, AQM (Active Queue Management) etc. Such mechanisms work well in landline based-solutions, but may work less well if the user accesses the server from a cellular system, i.e. from a RAN (Radio Access Network) in a communications system, a situation which is becoming increasingly common with the increased use of such cellular devices as smart phones, “tablets” etc. In such situations, the server will be located in the core network of the communications system, and the user, as mentioned above, will be located in a RAN of the communications system.

### SUMMARY

It is thus an object of the invention to obtain an improved solution for transmitting TCP packets from a server in a core network in a communications network to an end user who is located in a RAN in the communications network.

This problem is addressed by the invention by means of a TCP Proxy node for use in a communications network. The TCP Proxy node is arranged to receive TCP Packets originating from a first node in a core network in the communications network and to transmit said TCP Packets for reception by an end user in a radio access network in the communications network.

The TCP proxy node is arranged to be informed about an inactivity period during which the end user is unable to receive TCP Packets, and to schedule said transmissions of TCP Packets so that they are received by the end user outside of said inactivity period.

In embodiments, the TCP Proxy node is further arranged to be informed about the length of a TCP Packet queue for the end user in an intermediate node through which said TCP Packets are transmitted, and to also schedule transmissions of TCP Packets with respect to the length of said queue.

In embodiments, the TCP Proxy node is equipped with a buffer for TCP Packets received from the first node in the communications network, and the TCP Proxy node is being arranged to use the buffer in conjunction with said scheduling of the transmission of TCP Packets.

In embodiments, the TCP Proxy node is equipped with an interface towards the core network and an interface towards the radio access network.

In embodiments, the TCP proxy node is equipped with interfaces towards a first and a second other node in the radio access network.

In embodiments, the TCP Proxy node is arranged to be informed about said inactivity period by a scheduling function in a Radio Base Station in the Radio Access Network.

In embodiments, the TCP Proxy node is arranged to be informed about said length of a TCP Packet queue by a Radio Base Station in the Radio Access Network.

The problem to be solved is also addressed by the invention by means of a method for use in a communications network. The method comprises receiving in a TCP function in the communications network TCP Packets originating from a first node in a core network in the communications network.

The TCP Packets are destined for an end user in a radio access network in the communications network, and the method also comprises informing the TCP function of one or more inactivity periods during which the end user in the radio access network is unable to receive TCP packets.

The method further comprises scheduling the sending of TCP packets from the TCP function to the end user in the radio access network so that they are received by the end user outside of said inactivity period, and sending the TCP Packets from the TCP function to the end users.

In embodiments, according to the method, the TCP function is also informed of the length of a TCP Packet queue for the node in the radio access network in an intermediate node through which said TCP Packets are transmitted, and scheduling the sending of said TCP Packets with respect to the length of said queue.

In embodiments, the method comprises receiving information about the queue length from a Radio Base Station in the Radio Access Network.

In embodiments, the method comprises buffering TCP Packets received from the first node in the communications network in conjunction with the scheduling of the transmission of TCP Packets.

In embodiments, the method comprises informing the TCP function about said inactivity periods from a scheduling function in a Radio Base Station in the Radio Access Network.

In embodiments, according to the method, the TCP function is located in a Serving Gateway in the communications system.

In embodiments, according to the method, the TCP function is located in a stand-alone node in the communications system with an interface towards the core network and an interface towards the radio access network.

In embodiments, according to the method, the TCP function is located in a stand-alone node in the communications system with interfaces towards a first and a second other node in the radio access network.

### BRIEF DESCRIPTION OF THE DRAWINGS

The invention will be described in more detail in the following, with reference to the appended drawings, in which

FIG. 1 shows a network with an embodiment of a TCP Proxy node, and

FIG. 2 shows a network with another embodiment of a TCP Proxy node, and

FIG. 3 shows a block diagram of a TCP Proxy node, and

FIG. 4 shows a flow chart of a method for TCP transmissions.

### DETAILED DESCRIPTION

Embodiments of the present invention will be described more fully hereinafter with reference to the accompanying drawings, in which embodiments of the invention are shown. The invention may, however, be embodied in many different forms and should not be construed as being limited to the embodiments set forth herein. Like numbers in the drawings refer to like elements throughout.

The terminology used herein is for the purpose of describing particular embodiments only, and is not intended to limit the invention.

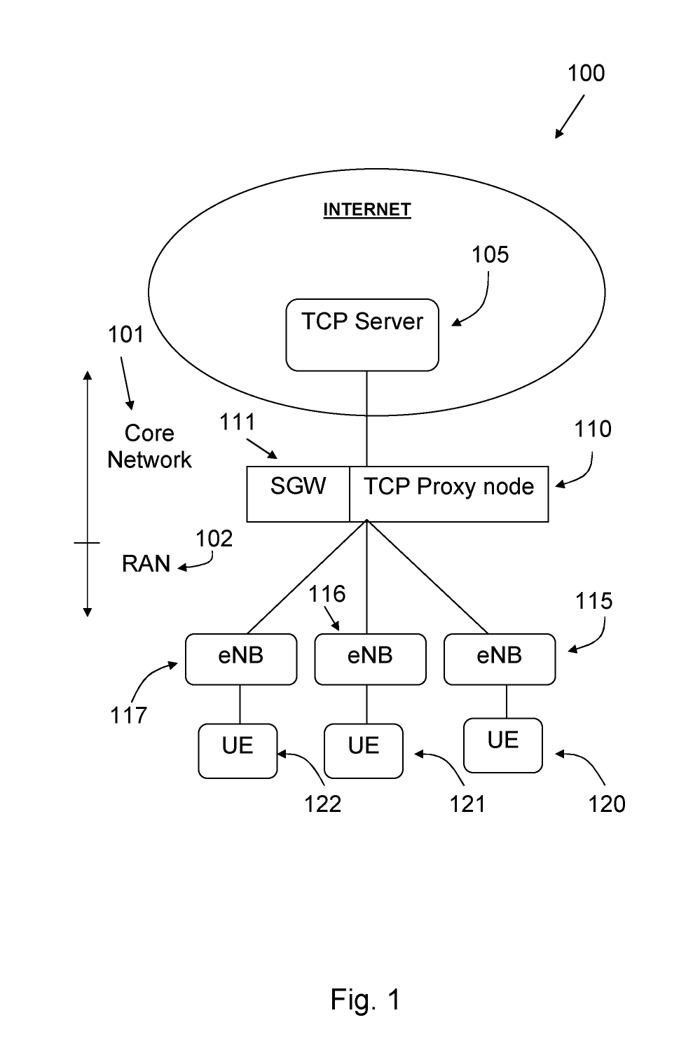

FIG. 1 shows an example of a communications network 100. As indicated by means of an arrow on the left-hand side of FIG. 1, the communications network 100 comprises a Core Network 101 and a Radio Access Network, RAN 102. The RAN may be of different kinds, for example EPC (LTE), GSM, WCDMA, CDMA 2000 etc, but will in the following mainly be described using LTE terminology.

In the example shown in FIG. 1, a number of “end users”, User Equipments, UEs 121, 121, 122 in the RAN 102 communicate with an Internet Server 105 in the Core Network 101 by means of the Transmission Control Protocol, TCP. For this reason, the Internet Server 105 is shown as a TCP server in FIG. 1, and will also be referred to as such below. The term “end user” is used above to signify the fact that the user may be any of a number of devices, e.g. a cellular telephone, a PC, a reading tablet etc. However, the term UE is used henceforth.

The UEs 120, 121, 122 (naturally, the number of UEs shown in FIG. 1 is only an example; the number can be larger or smaller than three) are connected to a controlling node of the cell to which they belong, a controlling node, sometimes generically referred to as a Radio Base Station, which in LTE systems is known as the eNodeB or eNB. The UEs can belong to one and the same cell, or they can belong to different cells, as indicated in FIG. 1, which shows each UE 120, 121, 122, connected to one eNB 115, 116, 117 each.

The UEs use so called DRX, Discontinuous Reception, which means that they alternate between a state referred to as DRX active, in which they “listen” to transmissions, and DRX passive, which is a state in which they do not listen to transmissions. Naturally, the DRX states are not common between the UEs, i.e. one UE will/may be in DRX active when another UE is in DRX passive.

In the TCP Server 105, the TCP Packets for each UE are generated and transmitted to the UE. As can be seen in FIG. 1, a TCP Packet intended for a UE will pass through a number of intermediary nodes between the TCP Server 105 and the UE. These “intermediary nodes” include a Serving Gateway, SGW 111, which is placed in the Core Network 101, and also include, as an example of a node in the RAN 102, a controlling node, eNB, of the cell to which the UE belongs. In addition, it should be understood that there may be other intermediary nodes which a TCP Packet passes on its way from the TCP Server 105 and a UE, although such intermediary nodes are not shown in FIG. 1.

In order to optimize the combination of transmissions of TCP Packets from the TCP Server 105 to the UEs 120, 121, 122, and the DRX states of the UEs, the system 100 comprises a TCP Proxy node 110. In FIG. 1, the TCP Proxy node is shown as being co-located with the SGW 111, which should be seen as an example only, the TCP Proxy can in principle be located anywhere between the TCP Server 105 and the UE, for example in the eNBs (in such a case with one TCP proxy node for each eNB in which it is desired to have the TCP Proxy function), or the TCP Proxy node can be a “stand alone” node in a more or less arbitrary location along the “path” between the TCP Server 105 and the UEs 120, 121, 122. However, in the case where, as shown in FIG. 1, the TCP Proxy node 110 is co-located with the SGW 111, the TCP Proxy node 110 is equipped with interfaces both towards the core network 101 and the RAN 102, for example an interface towards the SGW 111 and an interface towards the eNBs.

The function of the TCP Proxy node 110 is as follows: the TCP Proxy node 100 is arranged to receive the TCP Packets from the TCP Server 105 in the Core Network 102 in the communications network 110 and to transmit the TCP Packets for reception by the UEs 120, 121, 122. The TCP Proxy node 110 is also arranged to be informed about the DRX cycle (i.e. DRX ON/DRX OFF) of one or more, suitably all, of the UEs which utilize DRX, and schedules its transmissions to the UEs so that the UE will receive the TCP Packets intended for it during a DRX ON period, and not during a DRX OFF period. The information to the TCP Proxy node 110 about the DRX cycle of a UE can either be in the shape of pure cycle information, i.e. information about the duration of the DRX ON/OFF states of the UE and possibly a starting point for this DRX ON/OFF cycle, or it can, for example, be in the form of distinct points in time when a UE will enter the DRX states ON/OFF, etc.

In scheduling transmissions to the UEs, the TCP Proxy node may in embodiments avail itself of so called “timing advance”, i.e. transmission of TCP Packets to a certain UE is scheduled to be initiated ahead of the start of the UE's DRX ON period, with the “travel time” of the transmission to the UE from the TCP Proxy node being taken into consideration, so that the transmissions will arrive at the UE when the UE's DRX ON Period has been initiated. In a corresponding manner, transmission to a UE may cease before the DRX ON period has actually terminated, since transmission made from the TCP Proxy node at the exact point in time when DRX ON is terminated will arrive at the UE during a UE DRX OFF period.

In order to be able to schedule its transmissions to the UEs with respect taken to the UE's DRX ON/OFF periods, the TCP Proxy node is arranged to be informed about the DRX ON/OFF periods of the UEs. In embodiments, this information will originate from a UE scheduling function in the eNB of each UE, although the information may reach the TCP Proxy node from other nodes in the communications network 100, depending on where the TCP Proxy node is located in the communications network 100.

In embodiments, in order to further enhance the function of the TCP Proxy node 110, the TCP Proxy node 110 is also being arranged to be informed about the length of a TCP Packet queue for one or more of the UEs 120, 121, 122 which exists in an intermediate node, i.e. a node located between the TCP Proxy node 110 and the UE in question, and to schedule the transmissions of TCP Packets to a UE with respect to the length of this queue for the UE. An example of such a queue would be a TCP Packet queue for a UE in the eNB of the UE, in which case the information regarding the length of the queue would originate from the eNB although it may reach the TCP Proxy node 110 from other nodes.

A suitable use by the TCP Proxy node of the information regarding the length of a TCP Packet queue for a UE would be to schedule fewer TCP Packets for transmission to a UE which has a long queue (i.e. to “hold back” TCP Packets to such UEs), and to schedule more TCP Packets for transmission to UEs which have short or nonexistent queues. The length of a UE's TCP Packet queue may also be used by the TCP Proxy node 110 to decide a frequency with which TCP Packets are transmitted to a UE.

In order to be able to properly handle TCP Packets which are received from the TCP Server 105 and scheduled for transmission at later points in time, the TCP Proxy node 110 is in embodiments equipped with a buffer or a memory for TCP Packets received from the TCP Server 105, and the TCP Proxy node 110 is arranged to use the buffer (or memory) in conjunction with its scheduling of the transmission of TCP Packets, so that TCP Packets may be stored in the buffer/memory while awaiting transmission to a UE.

As mentioned, the TCP Proxy node 110 can be located in a large number of places in the communications system 100, but a suitable location is in or together with the SGW. In such an embodiment, the TCP Proxy node can interface with the SGW to both receive and transmit TCP Packages via the SGW 111.

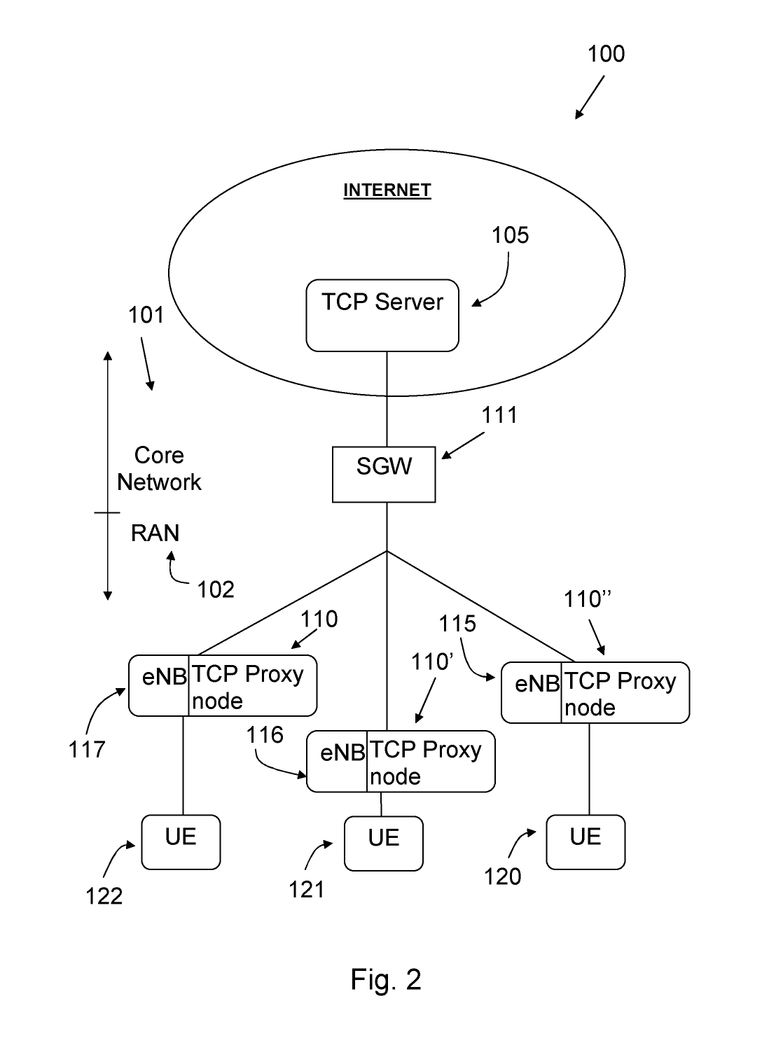

FIG. 2 shows another version of the communications network 100 from FIG. 1. In this version of the communications network 100, the TCP Proxy node is co-located with an eNB; FIG. 2 shows an example in which there is one TCP Proxy node 110, 110′, 110″, for each of the eNBs 115, 116, 117. In embodiments where the TCP Proxy node is located as shown in FIG. 2, the TCP Proxy node has an interface towards the SGW 111 and one interface towards the eNB with which it is co-located.

Alternatively, the TCP Proxy node can also be a “stand-alone” node between the eNB and the SGW 111.

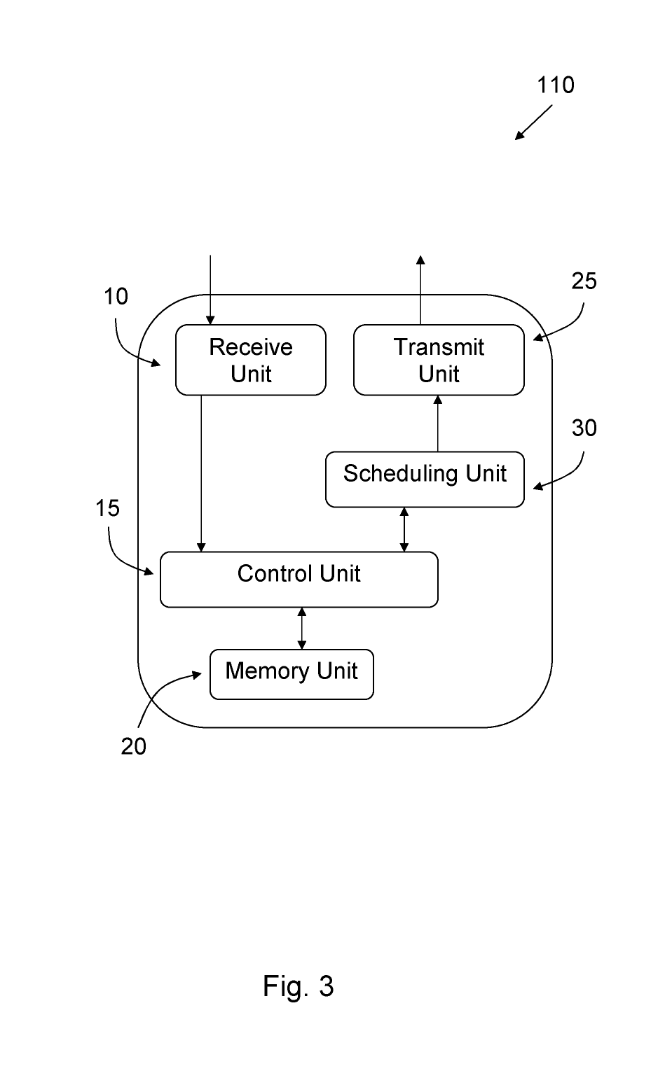

FIG. 3 shows a schematic block diagram of a TCP Proxy node 110. As shown in FIG. 3, the TCP Proxy node 110 comprises a receive unit 10 and a transmit unit 25. In addition, there is a control unit 15, a scheduling unit 30, and a memory unit 20. The exact division of tasks between these units may vary, but suitably, the TCP Proxy node 110 uses the receive unit in order to receive TCP Packets originating from a first node in the core network 101 in the communications network 100 and uses the transmit unit 25 in order to transmit TCP Packets for reception by an end user 120, 121, 122 in the RAN 102 in the communications network 100.

In addition, the TCP proxy node uses the receive unit to receive or be informed about the DRX period or periods of the UEs.

The function of the TCP Proxy node 110 is controlled by the control unit 15. Examples of such control include the control of the scheduling unit 30 so that transmission of TCP Packets is scheduled in such a manner that the TCP Packets are received by the UEs when they are in the DRX active state. In addition, the function of the receive unit and the transmit unit is also controlled by the control unit 15.

As can be seen in FIG. 3, the TCP Proxy node 110 also comprises a memory unit 20. The memory unit 20 is used in a variety of ways: it can, for example, comprise executable code to be used by the control unit and/or one of the other units in the TCP Proxy node 210. In embodiments where the TCP Proxy node 110 comprises a buffer for TCP Packets, this buffer can also be located in the memory unit 20.

It is also the receive unit and the transmit unit which comprise or serve as interfaces towards other nodes in the communications network 100, for example interfaces towards the CN 101 and the RAN 102, and/or interfaces towards a first and a second other node in the RAN 102.

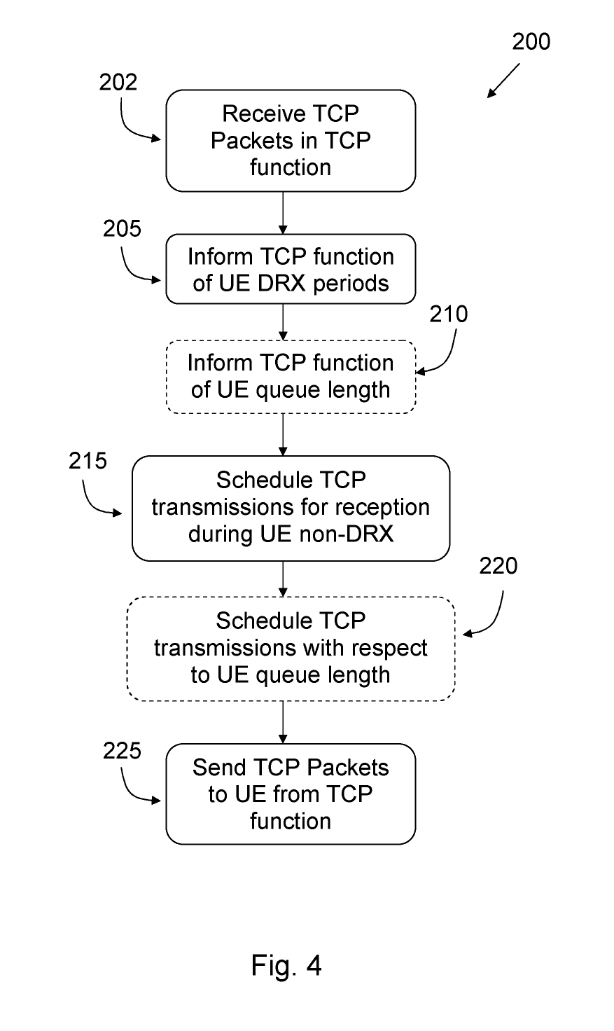

FIG. 4 shows a schematic flow chart of a method 200 for use in a communications network 100. Steps shown with dashed lines indicate steps which are optional or which occur in versions of the method 200. As shown in step 202, the method comprises receiving in a TCP function in the communications network 100 TCP Packets which originates from the TCP server 105 in the Core Network 101 in the communications network 100. The received TCP Packets are destined for an UE 120, 121, 122, in a radio access network 102 in the communications network 100.

As shown in step 205, the method 200 also comprises informing the TCP function of one or more inactivity periods during which the UE 120, 121, 122 in the radio access network 102 is unable to receive TCP packets, e.g. DRX periods.

As indicated in step 215, the method 200 further comprises scheduling the sending of TCP packets from the TCP function to the end user in the radio access network 100 so that they are received by the end user outside of the DRX period, and, step 225, sending the TCP Packets from the TCP function to the end users 120, 121, 122.

Step 210 shows that in embodiments, the method 200 comprises also informing the TCP function of the length of a TCP Packet queue for the UE in the radio access network in an intermediate node such as an eNB 115, 116, 117, through which the TCP Packets are transmitted to the end user. As shown in step 220, in embodiments, the TCP Proxy node also schedules the sending of the TCP Packets to a UE with respect to the length of said queue of the UE.

In embodiments, the method 200 comprises buffering TCP Packets received from the TCP Server 105 in the communications network 100 in conjunction with the scheduling of the transmission of TCP Packets.

In embodiments, the method 200 comprises informing the TCP function about the DRX periods from a scheduling function in a Radio Base Station, i.e. an eNB 115, 116, 117 in the Radio Access Network 100.

In embodiments, the method 200 comprises receiving the information about the queue length of a UE from a Radio Base Station, e.g. an eNB 115, 116, 117 in the Radio Access Network 100.

In embodiments of the method 200, the TCP function is located in a Serving Gateway in the communications system.

In embodiments of the method 200, the TCP function is located in a stand-alone node in the communications system with an interface towards the core network and an interface towards the radio access network.

Embodiments of the invention are described with reference to the drawings, such as block diagrams and/or flowcharts. It is understood that several blocks of the block diagrams and/or flowchart illustrations, and combinations of blocks in the block diagrams and/or flowchart illustrations, can be implemented by computer program instructions. Such computer program instructions may be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

In some implementations, the functions or steps noted in the blocks may occur out of the order noted in the operational illustrations. For example, two blocks shown in succession may in fact be executed substantially concurrently or the blocks may sometimes be executed in the reverse order, depending upon the functionality/acts involved.

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation.

The invention is not limited to the examples of embodiments described above and shown in the drawings, but may be freely varied within the scope of the appended claims.

1. A Transmission Control Protocol (TCP) Proxy node for use in a communications network, the TCP Proxy node being arranged to receive TCP Packets originating from a first node in a core network in the communications network and to transmit said TCP Packets for reception by an end user device in a radio access network in the communications network, the TCP proxy node being arranged to be informed about an inactivity period during which the end user device is unable to receive TCP Packets, and to schedule said transmissions of TCP Packets so that they are received by the end user device outside of said inactivity period.

2. The TCP Proxy node of claim 1, further being arranged to be informed about the length of a TCP Packet queue for the end user in an intermediate node through which said TCP Packets are transmitted to the end user, and to also schedule transmissions of TCP Packets with respect to the length of said queue.

3. The TCP Proxy node of claim 1, being equipped with a buffer for TCP Packets received from the first node in the communications network, the TCP Proxy node being arranged to use the buffer in conjunction with said scheduling of the transmission of TCP Packets.

4. The TCP Proxy node of claim 1, being equipped with an interface towards the core network and an interface towards the radio access network.

5. The TCP Proxy node of claim 1, being equipped with interfaces towards a first and a second other node in the Radio Access Network.

6. The TCP Proxy node of claim 1, being arranged to be informed about said inactivity period by a scheduling function in a Radio Base Station in the Radio Access Network.

7. The TCP Proxy node of claim 2, being arranged to be informed about said length of a TCP Packet queue by a Radio Base Station in the Radio Access Network.

8. A method for use in a communications network, the method comprising:
receiving in a TCP function in the communications network TCP Packets originating from a first node in a core network in the communications network, said TCP Packets being destined for an end user device in a radio access network in the communications network;
informing the TCP function of one or more inactivity periods during which said end user device in the radio access network is unable to receive TCP packets;
scheduling the sending of TCP packets from the TCP function to the end user device in the radio access network so that they are received by the end user outside of said inactivity period; and
sending said TCP Packets from the TCP function to the end user device.

9. The method of claim 8, according to which the TCP function is also informed of the length of a TCP Packet queue for the node in the radio access network in an intermediate node through which said TCP Packets are transmitted, and schedules the sending of said TCP Packets with respect to the length of said queue.

10. The method of claim 8, comprising buffering TCP Packets received from the first node in the communications network in conjunction with the scheduling of the transmission of TCP Packets.

11. The method of claim 8, comprising informing the TCP function about said inactivity periods from a scheduling function in a Radio Base Station in the Radio Access Network.

12. The method of claim 9, comprising receiving information about said queue length from a Radio Base Station in the Radio Access Network.

13. The method of claim 9, according to which the TCP function is located in a Serving Gateway in the communications system.

14. The method of claim 9, according to which the TCP function is located in a stand-alone node in the communications system with an interface towards the core network and an interface towards the radio access network.

15. A method for use in a communications network, the method comprising:
receiving at a packet forwarding device in the communications network a Transmission Control Protocol (TCP) packet destined for an end user device attached to a radio access network;
receiving at said packet forwarding device information identifying a period of time during which said end user device is unable to receive TCP packets;
the packet forwarding device scheduling the sending of said received TCP packet to the end user in the radio access network so that said TCP packet is received by the end user device outside of said identified period of time; and
the packet forwarding device forwarding said received TCP Packet to the end user device.
